(19) United States
(12) Patent Application Publication
(10) Pub. No.: US 2025/0203024 A1
(43) Pub. Date: Jun. 19, 2025

(54) IMAGE READING DEVICE AND IMAGE FORMING SYSTEM

(71) Applicant: Konica Minolta, Inc., Tokyo (JP)

(72) Inventor: Ayaka SUZUKI, Hachioji-shi (JP)

(21) Appl. No.: 18/975,368

(22) Filed: Dec. 10, 2024

(30) Foreign Application Priority Data
Dec. 14, 2023 (JP) 2023-211147

(51) Int. Cl. H04N 1/00; G03G 15/01

(52) U.S. Cl. CPC H04N 1/0057; G03G 15/0189; H04N 1/00034

(57) ABSTRACT

Disclosed is an image reading device including: a conveyer including a plurality of conveyance paths for conveying a recording medium on which an image is formed; a reader that reads the image; and a color measurer including a colorimeter that measures a color of the image. The conveyer includes a first conveyance path, a second conveyance path, and a third conveyance path on a downstream side of the reader in a conveyance direction, and path lengths of the second conveyance path and the third conveyance path are longer than a path length of the first conveyance path, and the color measurer is provided in the second conveyance path or the third conveyance path.

### CROSS REFERENCE TO RELATED APPLICATIONS

The present invention claims priority under 35 U.S.C. § 119 to Japanese Application No. 2023-211147, filed Dec. 14, 2023, the entire content of which is incorporated herein by reference.

### BACKGROUND OF THE INVENTION

### Technical Field

The present invention relates to an image reading device and an image forming system.

### Description of Related Art

Conventionally, there has been known an image reading device including a conveyance path that conveys a recording medium on which an image is formed by an image forming apparatus, a scanner that reads the image, and a colorimeter that measures the color of the image.

In an image reading device, it takes a predetermined time to inspect and determine whether a read image is good or not and to determine image quality or the like. Therefore, a configuration is known in which a bypass path is provided on the downstream side of the scanner and the colorimeter in the conveyance direction in order to secure the predetermined time during the sheet conveyance. However, providing the bypass path on the downstream side of the scanner and the colorimeter has a problem that the length in the conveyance direction (the lateral direction toward the front of the image reading device) from the scanner to the exit becomes long, and the size in the conveyance direction increases.

Therefore, for example, Japanese Unexamined Patent Publication No. 2021-061559 describes an image reading device in which a bypass path that bypasses a part of a sheet conveyance path is provided on a downstream side of a scanner, and a colorimeter is provided in the bypass path. Such an image reading device can reduce the length in the conveyance direction from the scanner to the exit, thereby achieving a reduction in size.

### SUMMARY OF THE INVENTION

However, in the invention of Japanese Unexamined Patent Publication No. 2021-061559, even when only the scanner is used, it is necessary to convey the recording medium through the bypass path provided with the colorimeter. Then, passage of the recording medium not subjected to color measurement through the bypass path may accelerate abrasion of rollers disposed on upstream and downstream sides of the colorimeter, scratch the colorimeter, or cause adhesion of a foreign substance, thereby degrading the color measurement accuracy of the colorimeter. Generally, a colorimeter is required to have high colorimetric accuracy, and therefore has a narrow allowable range for the depth of field. In addition, since an influence due to a scratch or adhesion of a foreign substance is also great, it is desirable to prevent the sheet from passing through the position of the colorimeter as much as possible when color measurement is not required.

The present invention has been made in view of such circumstances. An object of the present invention is to provide an image reading device and an image forming system capable of suppressing a decrease in the color measurement accuracy of a colorimeter.

To achieve at least one of the abovementioned objects, according to an aspect of the present invention, an image reading device reflecting one aspect of the present invention is an image reading device including:
a conveyer including a plurality of conveyance paths for conveying a recording medium on which an image is formed;
a reader that reads the image; and
a color measurer including a colorimeter that measures a color of the image, wherein the conveyer includes a first conveyance path, a second conveyance path, and a third conveyance path on a downstream side of the reader in a conveyance direction, and path lengths of the second conveyance path and the third conveyance path are longer than a path length of the first conveyance path, and the color measurer is provided in the second conveyance path or the third conveyance path.

To achieve at least one of the abovementioned objects, according to another aspect of the present invention, an image forming system reflecting one aspect of the present invention is an image forming system including:
an image forming apparatus that forms an image on a recording medium; and
the image reading device according to claim 1, wherein the image reading device conveys a recording medium on which an image has been formed by the image forming apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a side sectional view of the image forming system according to the first embodiment,

FIG. 2 is a block diagram of the image forming system,

FIG. 3 is a table summarizing the conveyance path of the recording medium for each mode of the image reading device,

FIG. 4A is a side cross-sectional view of an image reading device of an image forming system according to a second embodiment,

FIG. 4B is a side cross-sectional view of an image reading device of an image forming system according to a third embodiment; and

FIG. 4C is a side cross-sectional view of an image reading device of an image forming system according to a fourth embodiment.

### DETAILED DESCRIPTION

Hereinafter, an image forming system including an image reading device according to an embodiment of the present invention will be described in detail with reference to the drawings. However, the scope of the invention is not limited to the disclosed embodiments nor illustrated examples. In the following description, components having the same functions and configurations are denoted by the same reference numerals, and the description thereof will be omitted.

### [Overall Configuration of Image Forming System]

### First Embodiment

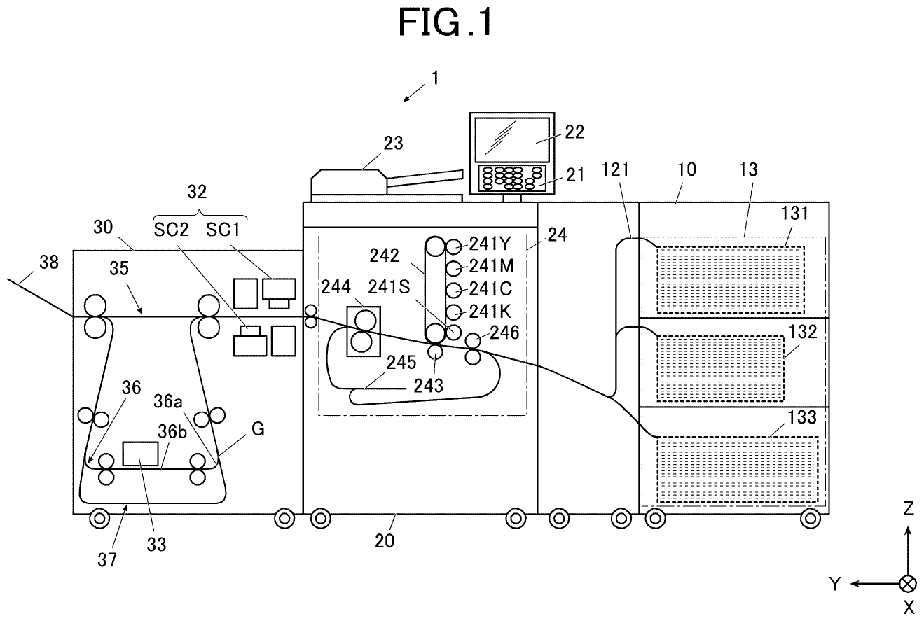

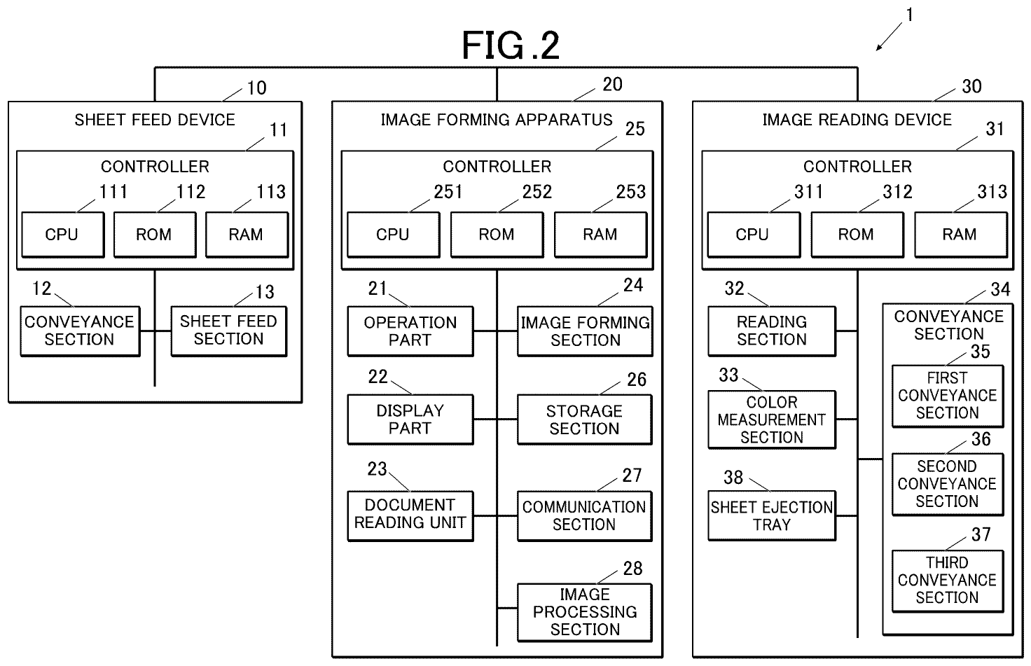

FIG. 1 is a side sectional view showing a main configuration of an image forming system 1 according to the first embodiment of the present disclosure. FIG. 2 is a block diagram illustrating a functional configuration of the image forming system 1.

Hereinafter, an X direction, a Y direction, and a Z direction refer to the directions illustrated in FIG. 1. Further, in the description below, the X direction, the Y direction, and the Z direction correspond to a width direction, a conveyance direction, and a height direction, respectively.

As illustrated in FIG. 1, the image forming system 1 includes a sheet feed device 10, an image forming apparatus 20, and an image reading device 30. The sheet feed device 10, the image forming apparatus 20, and the image reading device 30 are arranged in this order toward the downstream side in the conveyance direction of the recording medium. In addition, respective sheet conveyance paths of the sheet feed device 10, the image forming apparatus 20, and the image reading device 30 are connected. Therefore, recording media are continuously conveyed from the sheet feed device 10 to the image reading device 30 via the image forming apparatus 20.

### (Sheet Feed Device)

The sheet feed device 10 is an apparatus that supplies a stored recording medium to the image forming apparatus 20. The sheet feed device 10 includes a controller 11, a conveyance section 12, and a sheet feed section 13.

{Controller}

The controller 11 includes a CPU (Central Processing Unit) 111, a ROM (Read Only Memory) 112, and a RAM (Random Access Memory) 113. The CPU111 reads a program stored in the ROM112 and develops the program in the RAM113. The CPU111 integrally controls each unit of the sheet feed device 10 according to the expanded program. For example, the controller 11 conveys a recording medium from any of the sheet feed trays 131 to 133 of the sheet feed section 13 to the image forming apparatus 20 in accordance with a job. {conveyance section, sheet feed section}

The conveyance section 12 includes a conveyance path 121 and conveyance rollers (not illustrated). The conveyance path 121 connects the sheet feed section 13 to the image forming apparatus 20. The conveyance rollers convey the recording medium to a conveyance path 121. The sheet feed section 13 includes sheet feed trays 131 to 133 that store recording media according to predetermined sheet type and size.

A detection device that detects the physical properties of the recording medium may be provided between the sheet feed device 10 and the image forming apparatus 20.

### (Image Forming Apparatus)

The image forming apparatus 20 is located downstream of the sheet feed device 10 in the conveyance direction and upstream of the image reading device 30. The image forming apparatus 20 acquires image data by reading an image from a document or receiving image data from an external device (not illustrated). The image forming apparatus 20 forms an image on the basis of the acquired image data. After the image formation, the image forming apparatus 20 conveys the recording medium to the image reading device 30.

The image forming apparatus 20 includes an operation part 21, a display part 22, a document reading unit 23, an image forming section 24, a controller 25, a storage section 26, a communication section 27, and an image processing section 28.

### {Operation Part}

The operation part 21 includes, for example, a touch screen formed in such a manner as to cover a display screen of the display part 22, and various operation buttons such as numeric buttons and a start button. The operation part 21 outputs an operation signal based on a user's operation to the controller 25.

### {Display Part}

The display part 22 includes a liquid crystal display (LCD) or the like. The display part 22 displays various screens according to an instruction of a display signal input from the controller 25.

### {Document Reading Unit}

The document reading unit 23 includes an automatic document feeder (ADF) and a scanner. The document reading unit 23 outputs image data obtained by reading an image of a document to the controller 25.

### {Image Forming Section}

The image forming section 24 forms an image on the recording medium conveyed from the sheet feed device 10, on the basis of the acquired image data. In the present embodiment, the recording medium is a cut sheet. The image forming section 24 includes, for example, a photosensitive drum, an intermediate transfer belt 242, a secondary transfer roller 243, and a fixing section 244.

### [Photosensitive Drum]

The photosensitive drums include photosensitive drums individually corresponding to respective colors of, for example, yellow (Y), magenta (M), cyan (C), black (K), and a spot color(S). In the present embodiment, the spot color is exemplified by white. That is, the photosensitive drums include the photosensitive drum 241Y, 241M, 241C, 241K, and 241S.

The image forming section 24 uniformly charges the photosensitive drum 241Y, and then scans and exposes the surface with a laser beam to form a electrostatic latent image on the basis of the image datum for yellow color. Next, the image forming section 24 makes a yellow toner adhere to the electrostatic latent images on the 241Y of the photosensitive drums to develop the images. The photosensitive drums 241M to 241S form images similarly to the photosensitive drum 241Y except that they handle different colors, and therefore, description thereof is omitted.

### [Intermediate Transfer Belt]

The image forming section 24 transfers the toner images in the respective colors formed on the photosensitive drums 241Y to 241S onto the intermediate transfer belt 242. The transfer onto the intermediate transfer belt 242 is primary transfer. That is, the image forming section 24 forms a color toner image in which toner images of five colors are superimposed on the intermediate transfer belt 242.

### [Secondary Transfer Roller]

The image forming section 24 collectively transfers the color toner images on the intermediate transfer belt 242 onto a recording medium by a secondary transfer roller 243. The transfer onto a recording medium is second transfer. A nip part formed by the intermediate transfer belt 242 and the secondary transfer roller 243 is a transfer section.

### [Fixing Section]

The fixing section 244 includes a heating roller and a pressure roller. The heating roller heats the recording medium onto which the color toner image has been transferred. The pressure roller presses the recording medium heated by the heating roller. By the heating and pressing of the fixing section 244, the color toner image is fixed on the recording medium.

### {Controller}

The controller 25 includes CPU251, ROM252, and RAM253. The CPU251 reads various processing programs stored in the ROM252 and develops the programs in the RAM253. The controller 25 comprehensively controls the operation of the image forming apparatus 20 in cooperation with various programs developed in the RAM 253.

### {Storage Section}

The storage section 26 stores data such as program data and various types of setting data so that the controller 25 can read and write the data. The storage section 26 also stores the sheet feed trays 131 to 133 and information on the basis weight, size, sheet type, and the like of the recording media stored therein in association with each other. The storage section 26 is a nonvolatile storage device such as a hard disk drive (HDD) or a semiconductor memory that stores various types of data such as programs and image data.

### {Communication Section}

The communication section 27 transmits and receives various types of data to and from an external device such as a personal computer connected to a communication network such as a local area network (LAN) or a wide area network (WAN). The communication section 27 includes a communication control card such as a LAN card.

### {Image Processing Section}

The image processing section 28 performs necessary image processing on image data before image formation. The image data includes data stored in the storage section 26, data acquired by reading a document with the document reading unit 23, and data input from an external device.

Then, the image processing section 28 transmits the image data after the image processing to the image forming section 24. The image processing includes tone processing, halftone processing, color conversion processing, and the like. The tone processing is processing for converting a gradation value of each pixel of image data into a gradation value corrected so that a density characteristic of an image formed on a recording medium coincides with a target density characteristic. The halftone processing is error diffusion processing, screen processing using an ordered dither method, or the like. The color conversion processing is converting each gradation value of RGB into each gradation value of CMYK.

The processing of the image processing section 28 described above may be realized by a program executed by the CPU of the controller 25.

### (Image Reading Device)

The image reading device 30 is disposed on the downstream side of the image forming apparatus 20 in the conveyance direction. The image reading device 30 includes a controller 31 (hardware processor), a reading section 32 (reader), a color measurement section 33 (color measurer), a conveyance section 34 (conveyer), and a sheet ejection tray 38. The image reading device 30 reads the recording medium conveyed from the image forming apparatus 20 and acquires image data (read image data).

### {Controller}

The controller 31 includes CPU311, ROM312, and RAM313. The CPU311 reads various processing programs stored in the ROM312 and develops the programs in the RAM313. The controller 31 integrally controls the operation of the image forming apparatus 20 in cooperation with various programs developed in the RAM313.

### {Reading Section}

The reading section 32 is provided in a first conveyance path 35, which will be described later, of the conveyance section 34, on the upstream side in the conveyance direction from a branching position between a second conveyance path 36 and a third conveyance path 37. The reading section 32 is disposed on the downstream side of the image forming section 24 in the conveyance direction. Therefore, the reading section 32 can read an image while the recording medium is being conveyed.

As illustrated in FIG. 1, the reading section 32 in the present embodiment includes individual color scanners on both sides of the recording medium conveyed in the first conveyance path 35. The first scanner SC1, which is one of the scanners, reads an image on a first side, for example, an upper side of the recording media. The second scanner SC2, which is the other scanner, reads an image on a second side of the recording medium opposite to the first side, for example, the bottom side.

The reading section 32 acquires read image data by reading an image formed on a recording medium by the image forming section 24. Then, the reading section 32 outputs the acquired read image data to the image processing section 28. The image processing section 28 not only performs image processing on image data before image formation but also analyzes image data read by the reading section 32.

Specifically, the image processing section 28 calculates, from the read image data, a positional deviation amount of the image formed on each of the front surface and the back surface of the recording medium with respect to the recording medium, an adjustment value of the positional deviation, an adjustment value of the color of the image, and the like. The image processing section 28 also detects a defect in the image formed on the recording medium from the read image data. The image processing section 28 outputs an analysis result of the read image data to the controller 25 of the image forming apparatus 20. Furthermore, the controller 31 performs various kinds of calibration based on the read image data read by the reading section 32.

### {Color Measurement Section}

The color measurement section 33 is provided in a parallel portion (in the present embodiment, a horizontal portion 36b of the second conveyance path 36) of either the second conveyance path 36 or a third conveyance path 37 which will be described later. The color measurement section 33 includes a spectral colorimeter C and a drive section (not illustrated) that causes the spectral colorimeter C to scan in a width direction. The color measurement section 33 measures the color of the chart image recorded on the recording medium conveyed through the second conveyance path 36 or the third conveyance path 37 by scanning the spectral colorimeter C in the width direction by the drive section. The color measurement section 33 outputs the color measurement result of the chart image to the controller 31. The controller 31 creates a color profile based on the gradation value measured by the color measurement section 33, and transmits the color profile to the image forming apparatus 20. The controller 25 corrects the hue with reference to the color profile when an image is formed by the image forming section 24.

### {Conveyance Section}

The conveyance section 34 includes a conveyance path that connects from the image forming apparatus 20 to the sheet ejection tray 38, and a plurality of conveyance rollers that convey the recording medium on the conveyance path. The conveyance path includes, for example, a first conveyance path 35 connecting from the image forming apparatus 20 to a sheet ejection tray 38. Furthermore, the conveyance path includes a second conveyance path 36 and a third conveyance path 37 that branch from the middle of the first conveyance path 35, detour downward, and then merge with the first conveyance path 35 again on the downstream side of the branch portion.

### [First Conveyance Path]

The first conveyance path 35 is, for example, a conveyance path used when a recording medium is normally conveyed. The first conveyance path 35 is provided so as to connect substantially linearly from a connecting part with the image forming apparatus 20 which is an entrance portion of the image reading device 30 to the sheet ejection tray 38 which is an exit portion. With the above-described configuration, the sheet can be conveyed in the shortest distance from the image formation of the image forming apparatus 20 to the sheet ejection to the sheet ejection tray 38, and the productivity of the image forming system 1 can be further improved.

### [Second Conveyance Path]

The second conveyance path 36 is a conveyance path that branches from the first conveyance path 35, greatly detours downward, and then turns upward to merge with the first conveyance path 35. In the present embodiment, the second conveyance path 36 includes an inclined portion 36a and a horizontal portion 36b. The inclined portion 36a is a linear portion that is provided between a junction with the first conveyance path 35 and a horizontal portion 36b in the second conveyance path 36 and is formed to be inclined downward. The horizontal portion 36b is a linear portion which is provided at a lower end portion of the second conveyance path 36 and is formed in parallel with a horizontal direction. Note that the path length of the second conveyance path 36 is longer than the path length of the first conveyance path 35.

### [Third Conveyance Path]

The third conveyance path 37 is a conveyance path that, when branching from the second conveyance path 36, makes a further downward detour than the second conveyance path 36 and then turns upward to merge with the second conveyance path 36. As described above, in the present embodiment, a part of the third conveyance path 37 also serves as a part of the second conveyance path 36. Therefore, the path length of the third conveyance path 37 is longer than the path lengths of the first conveyance path 35 and the second conveyance path 36.

At the branching position from the first conveyance path 35 to the second conveyance path 36 and the branching position from the second conveyance path 36 to the third conveyance path 37, branching guides G are arranged that can change the course of the recording medium. The direction of the branching guide G can be changed by an actuator controlled by the controller 31. The controller 31 changes the direction of the branch guide G to appropriately switch the conveyance path of the recording medium between the second conveyance path 36 and the third conveyance path 37.

Note that any of the first conveyance path 35, the second conveyance path 36, and the third conveyance path 37 may be formed by a guide or a wall part for guiding the recording medium along the conveyance path. Furthermore, the first conveyance path 35, the second conveyance path 36, and the third conveyance path 37 may be formed with a plurality of guide rollers arranged side by side along each path.

### {Sheet Ejection Tray}

The sheet ejection tray 38 is connected to an exit portion of the image reading device 30. A plurality of sheet ejection trays 38 are provided, and sheet is ejected to different places according to the reading result of the recording medium.

### Effects of First Embodiment

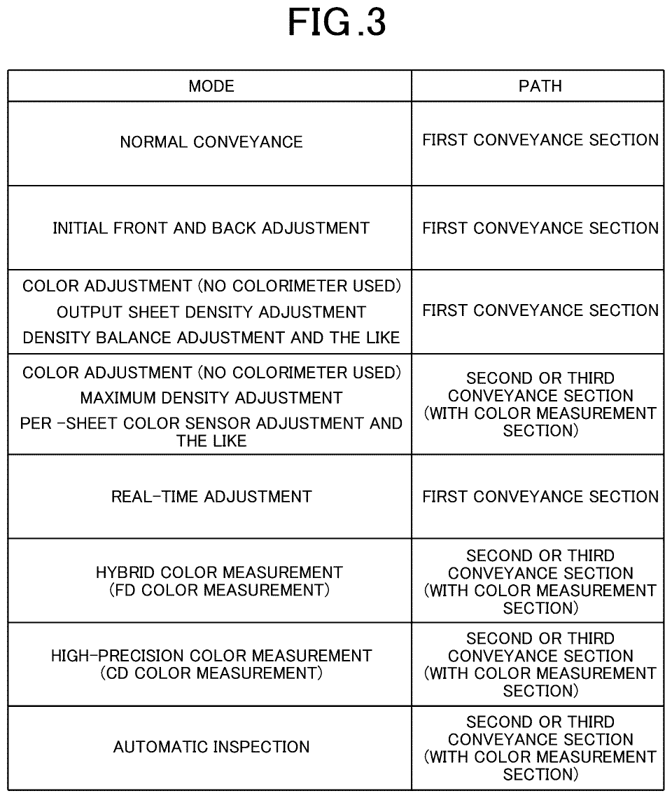

FIG. 3 is a table which summarizes the conveyance paths for conveying the recording medium in each mode. As shown in FIG. 3, the controller 31 conveys the recording medium on which the color measurement of the image is performed by the color measurement section 33 to the second conveyance path 36 provided with the color measurement section 33. Further, the controller 31 conveys the recording medium to be automatically inspected by reading the image with the reading section 32 to the third conveyance path 37 which is a bypass path. Next, the controller 31 conveys the recording medium, which is neither a target of reading by the reading section 32 nor a target of color measurement by the color measurement section 33, to the first conveyance path 35. Furthermore, the image reading device 30 of the image forming system according to the present embodiment separately includes the first conveyance path 35, the second conveyance path 36, and the third conveyance path 37 as the conveyance section 34. As described above, since the image reading device 30 does not use the second conveyance path 36 provided with the color measurement section 33 as a bypass path after reading by the reading section 32, it is possible to suppress a decrease in the color measurement accuracy of the spectrophotometer C.

Furthermore, according to the above configuration, for example, while the first recording medium is being conveyed in the second conveyance path 36, the second recording medium can be conveyed in the first conveyance path 35 or the third conveyance path 37. When the color of the image is measured by the color measurement section 33, the conveyance speed of the recording medium needs to be lower than that when the color is not measured. Therefore, the second recording medium that is a recording medium subsequent to the first recording medium as a color measurement target and does not require color measurement is conveyed through the first conveyance path 35 or the third conveyance path 37 in which no colorimeter is disposed, thus allowing the conveyance speed of the subsequent recording medium to be increased. As a result, the productivity of the image forming processing can be increased.

Furthermore, in the conveyance section 34, the first conveyance path 35 is linear from the entrance portion to the exit portion. On the other hand, the second conveyance path 36 is a conveyance path detouring downward, and the third conveyance path 37 is a conveyance path detouring further downward with respect to the second conveyance path 36. The second conveyance path 36 and the third conveyance path 37 that are branched from the first conveyance path 35 merge with the first conveyance path 35. Therefore, the length of the image reading device 30 in the conveyance direction (size in the lateral direction when facing the front of the image reading device 30) can also be suppressed.

### Second Embodiment

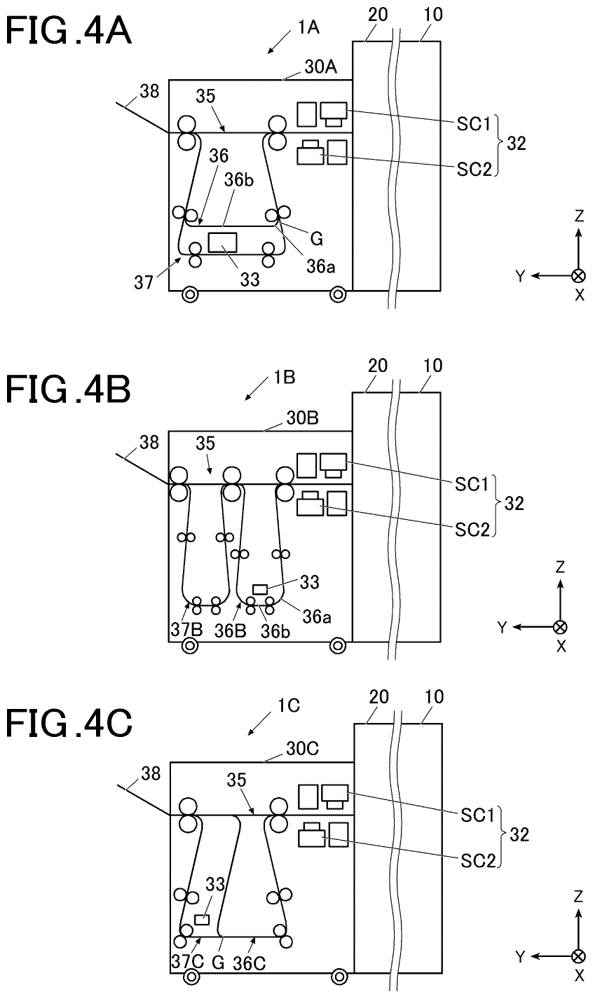

Next, an image forming system 1A according to a second embodiment will be described with reference to FIG. 4A. Note that contents that are the same as those of the first embodiment are denoted by the same reference signs, and a detailed description thereof will be omitted. As illustrated in FIG. 4A, the image forming system 1A of the second embodiment is different from the first embodiment in the configuration of a conveyance section 34 of an image reading device 30A.

Specifically, in the second embodiment, the color measurement section 33 is provided not in the second conveyance path 36 but in the third conveyance path 37. In addition, in the second embodiment, the controller 31 conveys the recording medium in the second conveyance path 36 in which the color measurement section 33 is not provided as the bypass path after the reading of the reading section 32.

### [Effects of Second Embodiment]

The image reading device 30A according to the second embodiment also includes a conveyance path (third conveyance path 37) along which the recording medium is conveyed when the color measurement section 33 measures the color of the image, and a conveyance path (second conveyance path 36) along which the recording medium is conveyed after the reading section 32 reads the image, separately. Therefore, similarly to the first embodiment, a decrease in the color measurement accuracy of the spectral colorimeter C can be suppressed. As described above, in the image reading device 30 (30A), the color measurement section 33 can be provided in either the second conveyance path 36 or the third conveyance path 37.

### Third Embodiment

Next, an image forming system 1B according to a third embodiment will be described with reference to FIG. 4B. Note that elements that are the same as those described in the first and second embodiments are denoted by corresponding ones of the reference numerals, and detailed description of those elements is omitted. As illustrated in FIG. 4B, the image forming system 1B of the third embodiment is different from the first and second embodiments in the configuration of a conveyance section 34 of an image reading device 30B.

Specifically, in the third embodiment, the third conveyance path 37B separate from the second conveyance path 36B is provided so as to branch from the first conveyance path 35 on the downstream side relative to the second conveyance path 36. [Effects of Third Embodiment]

In the first and second embodiments, the third conveyance path is configured to branch from the second conveyance path 36 so as to detour downward, and therefore, there is a design constraint that the path length of the third conveyance path is always longer than the path length of the second conveyance path 36. On the other hand, since the second conveyance path 36B and the third conveyance path 37B are separate bodies in the third embodiment, the path lengths of the second conveyance path 36B and the third conveyance path 37B can be appropriately and arbitrarily set.

Note that although the configuration in which the color measurement section 33 is provided in the second conveyance path 36B is illustrated in FIG. 4B, the configuration is not limited thereto. That is, also in the image reading device 30B according to the third embodiment, the color measurement section 33 may be provided in the third conveyance path 37B similarly to the second embodiment.

### Fourth Embodiment

Next, an image forming system 1C according to a fourth embodiment will be described with reference to FIG. 4C. The same components as those in the first to third embodiments are denoted by the same reference numerals, and detailed description thereof will be omitted. As illustrated in FIG. 4C, the image forming system 1C of the fourth embodiment is different from the first to third embodiments in the configuration of the conveyance section 34 of the image reading device 30C.

Specifically, in the fourth embodiment, the third conveyance path 37C is branched from part of the second conveyance path 36C, and the third conveyance path 37C is provided so as to be located on the downstream side of the second conveyance path 36C. Recording media that do not require color measurement by the color measurement section 33 are conveyed through the second conveyance path 36C, and then merge with the first conveyance path 35 without being sent to the third conveyance path 37C. The recording medium requiring color measurement by the color measurement section 33 is conveyed to the second conveyance path 36C, then sent to the third conveyance path 37C, subjected to color measurement via the position of the color measurement section 33, and then merges with the first conveyance path 35.

### [Effects of Fourth Embodiment]

Also in the above-described configuration, similarly to the third embodiment, since the third conveyance path 37C is provided on the downstream side of the second conveyance path 36C, the path lengths of the second conveyance path 36C and the third conveyance path 37C can be appropriately and arbitrarily set. On the other hand, unlike the third embodiment, the third conveyance path 37C is branched from a part of the second conveyance path 36C, thus allowing a reduction in the number of components such as conveyance paths and conveyance rollers.

Note that in the above-described configuration, it is preferable that the color measurement section 33 is not provided in the second conveyance path 36C and the color measurement section 33 is provided only in the third conveyance path 37C. This is because, in a case where the color measurement section 33 is provided in the second conveyance path 36C, there is a risk that the recording medium conveyed in the third conveyance path 37C passes below the color measurement section 33 and the color measurement accuracy of the spectral colorimeter C decreases.

### [Other Configurations]

Although the present invention has been described in detail based on the embodiment, the present invention is not limited to the above-described embodiment. Of course, various modifications are possible within the scope of the invention described in the claims and their equivalents.

For example, the configuration in which the second conveyance path 36 and the third conveyance path 37 are provided so as to bypass below the first conveyance path 35 has been exemplified in the description above, but it is not limited thereto. That is, the second conveyance path 36 and/or the third conveyance path 37 may be provided so as to bypass the first conveyance path 35, for example, upward.

Furthermore, the configuration in which the reading section 32 includes two scanners (the first scanner SC1 and the second scanner SC2) has been described above as an example, but this is not limiting. For example, in a case where the image forming apparatus 20 forms an image only on one side of a recording medium, a configuration may be adopted in which only one scanner is included.

In addition, in the above description, a configuration in which the image forming apparatus 20 forms an image by an electrophotographic method using toner has been exemplified, but the present invention is not limited thereto. The present disclosure is also applicable to a case where the image forming apparatus 20 is configured to form an image by an inkjet method using ink.

Furthermore, although the configuration in which the sheet feed device 10, the image forming apparatus 20, and the image reading device 30 include the controllers 11, 25, and 31, respectively, and cooperate with each other has been described above as an example, it is not limited thereto. That is, a configuration may be adopted in which only one controller that comprehensively controls the image forming system 1 is included. In addition, an apparatus separate from the sheet feed device 10, the image forming apparatus 20, and the image reading device 30 may include such a controller.

According to the embodiment, it is possible to suppress a decrease in the color measurement accuracy of the colorimeter.

Although embodiments of the present invention have been described and shown in detail, the disclosed embodiments are made for purposes of illustration and example only and not limitation. The scope of the present invention should be interpreted by terms of the appended claims.

What is claimed is:

1. An image reading device comprising:
a conveyer including a plurality of conveyance paths for conveying a recording medium on which an image is formed;
a reader that reads the image; and
a color measurer including a colorimeter that measures a color of the image, wherein
the conveyer includes a first conveyance path, a second conveyance path, and a third conveyance path on a downstream side of the reader in a conveyance direction, and path lengths of the second conveyance path and the third conveyance path are longer than a path length of the first conveyance path, and
the color measurer is provided in the second conveyance path or the third conveyance path.

2. The image reading device according to claim 1, wherein the second conveyance path and the third conveyance path are branched from the first conveyance path, and merge with the first conveyance path on a downstream side in a conveyance direction of a branch portion from the first conveyance path.

3. The image reading device according to claim 2, wherein the third conveyance path is branched from the second conveyance path.

4. The image reading device according to claim 3, wherein
the first conveyance path is formed linearly from an entrance portion toward an exit portion,
the second conveyance path is provided so as to detour vertically downward with respect to the first conveyance path, and
the third conveyance path is provided so as to detour vertically downward with respect to the second conveyance path.

5. The image reading device according to claim 2, wherein
the first conveyance path is formed linearly from an entrance portion toward an exit portion,
the second conveyance path is provided so as to detour vertically downward with respect to the first conveyance path, and
the third conveyance path is provided so as to detour vertically downward on a downstream side of the second conveyance path with respect to the first conveyance path.

6. The image reading device according to claim 1, further comprising a hardware processor that controls the conveyer to convey a recording medium that is a color measurement target by the colorimeter in a conveyance path among the second conveyance path and the third conveyance path in which the color measurer is provided, and to convey a recording medium that is not the color measurement target by the colorimeter in a conveyance path among the first conveyance path, the second conveyance path, and the third conveyance path in which the color measurer is not provided.

7. The image reading device according to claim 6, wherein the hardware processor controls the conveyer to convey, in the first conveyance path, a recording medium that is neither a reading target by the reader nor the color measurement target by the colorimeter.

8. The image reading device according to claim 1, wherein the reader includes a first scanner that reads an image on a first side of the recording medium, and a second scanner that reads an image on a second side of the recording medium opposite to the first side.

9. The image reading device according to claim 6, wherein the hardware processor causes a recording medium that is a reading target by the reader and is not the color measurement target by the colorimeter to be conveyed in a conveyance path that is not provided with the color measurer among the second conveyance path and the third conveyance path.

10. An image forming system comprising:
an image forming apparatus that forms an image on a recording medium; and
the image reading device according to claim 1, wherein the image reading device conveys a recording medium on which an image has been formed by the image forming apparatus.
